(19) United States
(12) Patent Application Publication
(10) Pub. No.: US 2009/0301269 A1
(43) Pub. Date: Dec. 10, 2009

(54) HUB LOCKNUT SOCKET TOOL

(76) Inventor: William Wedge, Orange, CA (US)

Correspondence Address: WEST & ASSOCIATES, A PC, 1255 Treat Blvd., 3rd Floor, WALNUT CREEK, CA, 94597, US

(21) Appl. No.: 12/464,417

(22) Filed: May 12, 2009

Related U.S. Application Data
(60) Provisional application No. 61/058,614, filed on Jun. 4, 2008.

(51) Int. Cl. B25B 13/06; B25B 13/48

(52) U.S. Cl. 81/124.2; 81/124.6

(57) ABSTRACT

A hub locknut socket tool, specifically a socket that can selectively couple with a standard or custom ratchet and a variety of hub locknuts, including but not limited to Myers hub locknuts and T&B® (electrical fitting/connector) hub locknuts. The hub locknut socket is easier to use and more efficient than the traditional method of using a hammer-screwdriver combination or wrench to tighten or loosen a hub locknut. The hub locknut socket also provides a higher level of safety as compared to previous methods.

### CLAIM OF PRIORITY

The following application claims priority to U.S. Provisional Patent Application No. 61/058,614, filed Jun. 4, 2008, the complete contents of which are hereby incorporated by reference.

### BACKGROUND

1. Field of the Invention

The present disclosure relates to the field of hand tools, specifically a conduit hub locknut socket tool for installation and removal of conduit hub locknuts.

2. Background

Electricians often install rigid metal conduit, intermediate metal conduit, PVC coated rigid metal conduit and other conduits in applications which require the use of conduit hubs when terminating into an electrical enclosure, junction box, wireway, gutter, switchboard, transformer, and/or apparatus. Traditionally, the conduit hub locknut is installed and securely tightened with force in a clockwise direction by the use of a wrench or hammer blows against the handle end of a screwdriver, with the flat end of the screwdriver making contact with the hub locknut. As an example, in their product catalog, the complete contents of which are hereby incorporated by reference, Thomas & Betts® recommends using a wrench or hammer-and-screwdriver combination for tightening or loosening their T&B® (electrical fitting/connector) hub locknuts (Thomas & Betts®, T&B® Fittings, p. A-17, available at http://tnbelectricalworld.tnb.com/contractor/docs/tc_gm101_xx.pdf). However, in many applications, due to limited access, tight working conditions, obstructions from electrical devices and mechanisms within enclosures and general designs of electrical enclosures and apparatus, the use of a wrench or hammer-and-screwdriver combination is cumbersome, difficult, can cause damage to electrical equipment, and can be potentially hazardous to personnel.

Many applications do not accommodate the amount of space needed to property execute hub locknut installation via the wrench or hammer-screwdriver methods. When using a wrench for conduit hub locknut installations, the wrench needs to be large enough to grasp the outer shell of the conduit hub locknut and apply force while turning. The installer must grip the wrench and turn the conduit hub locknut with the gripping hand on the same surface plane as the enclosure while the conduit hub locknut tightens against the enclosure. If the wrench used is too small and/or small spaces do not allow for proper execution, this process can result in the wrench suddenly and quickly slipping off the conduit hub locknut.

When a hammer-screwdriver method is utilized, the flat end of the screwdriver must be held firmly against the flat edge of the conduit hub locknut and a hammer must strike the screwdriver handle repeatedly. This process enables rotation and tightening of the hub locknut. The installer must both keep the screwdriver in the same surface plane as the enclosure and grip the screwdriver handle such that enough space is allotted for receiving hammer blows without striking the installer's hand. Moreover, the screwdriver must be large enough to seat firmly against a flat edge of the conduit hub locknut and strong enough to receive hammer blows. Not only does this process inherently carry safety risks, but in many instances there is not enough space for proper execution.

With both the wrench and hammer-screwdriver methods, there can be a great risk of injury to the installer and damage to electrical equipment as a result of a screwdriver slip or awkward strike by hammer blow. Accordingly, cardboard and rubber mats are sometimes used by installers to protect electrical devices, controls, wiring and mechanisms. Additionally, an installer may use gloves to minimize hand lacerations, bruises, or other injuries. Nevertheless, it is desirable to have a device that can greatly lessen the risk of injury to person or property without using mats, gloves, or the like.

What is needed is a hub locknut socket adapted for installation and removal of conduit hub locknuts within electrical enclosures, junction boxes, wireways, gutters, switchboards, transformers and other apparatuses. The socket should require less force by a user, as compared to current methods, and should lessen the risk of damage to electrical equipment while lowering potential hazards to a user. It is desirable to have a socket that can be used with standard or custom ratchets. The socket should be adapted for use with a variety of hub locknuts, including but not limited to Meyers hub locknuts and T&B® (electrical fitting/connector) hub locknuts.

### BRIEF DESCRIPTION OF THE DRAWINGS

FIG. 1 depicts a perspective view of one embodiment of the present device.

FIG. 2 depicts a perspective cross-section view of another embodiment of the present device.

FIG. 2A depicts a perspective view of a typical Meyers hub locknut.

FIG. 3 depicts a top view of the embodiment shown in FIG. 1.

FIG. 4 depicts a bottom view of the embodiment shown in FIGS. 1 and 6.

FIG. 5 depicts a top view of a T&B® (electrical fitting/connector) hub locknut.

FIG. 6 depicts a perspective view of another embodiment of the present device, specifically designed for use with T&B® (electrical fitting/connector) hub locknuts.

FIG. 7 depicts a perspective cross-section view of another embodiment of the device shown in FIG. 6.

FIG. 8 depicts a top view of one embodiment of the present device designed for use with T&B® Hub (electrical fitting/connector) locknuts.

FIG. 9 depicts a top view of another embodiment of the present device designed for use with T&B® Hub (electrical fitting/connector) locknuts.

FIG. 10 depicts a sectioned side view of a rib member of the device in FIGS. 7 & 9 coupled with a T&B® (electrical fitting/connector) hub locknuts.

FIG. 11 depicts a perspective view of another embodiment of the present device.

FIG. 12 depicts a top view of an embodiment of the present device comprising rib members and appendages.

FIG. 13 depicts a side view of one embodiment of the present device in use.

### DETAILED DESCRIPTION

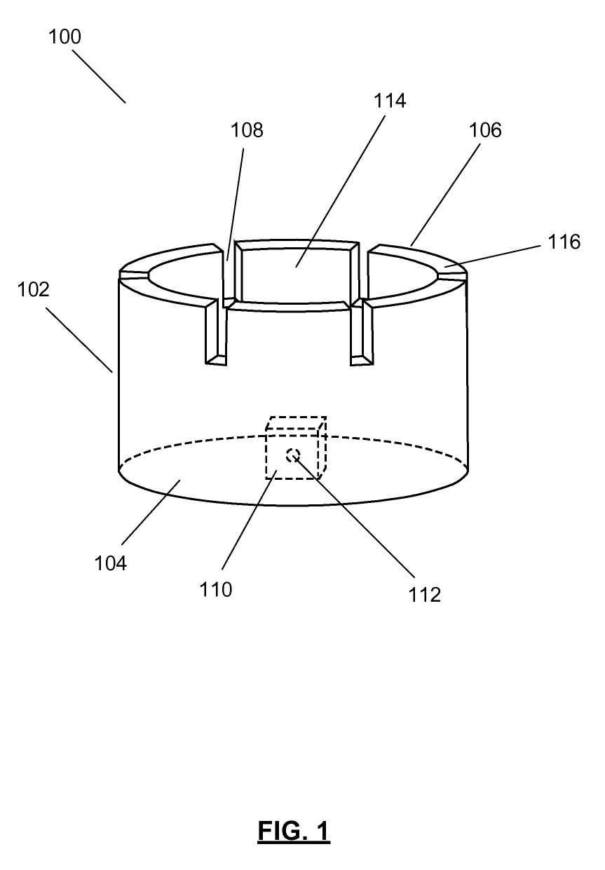

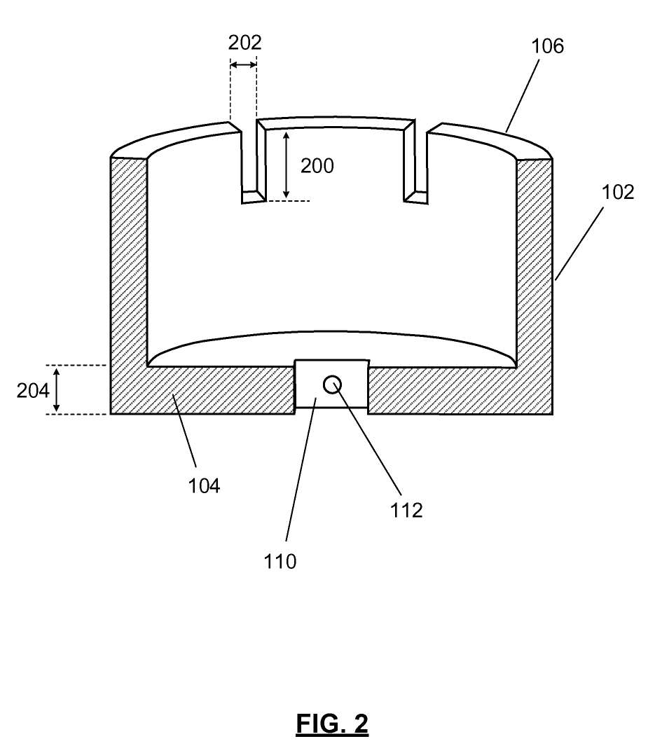

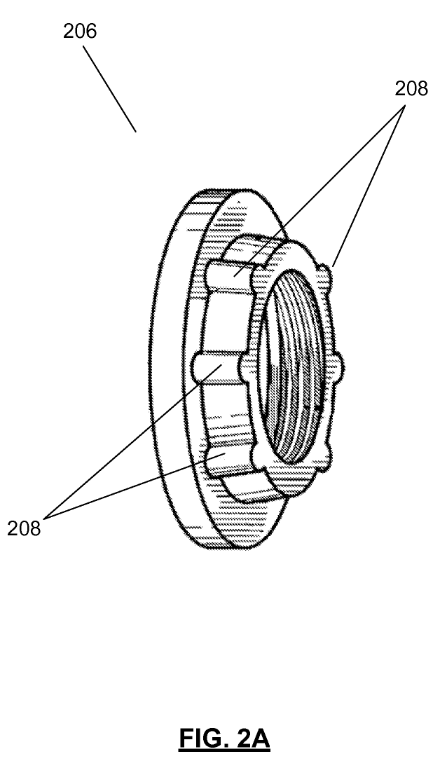

FIG. 1 depicts a perspective view of the present invention. A hub locknut socket 100 can comprise a substantially tubular body 102 having a proximal end and a distal end. A plurality of extension members 106 can extend from the proximal end of a substantially tubular body 102 and can be substantially equally spaced relative to each other. In other embodiments, a plurality of extension members 106 can have gaps 108 wherein at least one gap 108 is a different size than another gap 108. The size of gaps 108 between extension members 106 can be predetermined such that the extension members 106 coupled with a substantially tubular body 102 are adapted to selectively engage the lugs of a hub locknut, as explained further below. The distal end of a substantially tubular body 102 can be coupled with a flange 104 and a cavity 110. A cavity 110 can comprise a ball detent 112 and can be adapted to receive a ratchet drive of predetermined size. A cavity 110 can have a substantially rectangular opening and can be a depression, as shown in FIG. 1, or an aperture, as shown in FIG. 2. The proximal end of an extension member 106 can form a substantially planar brim 116, as depicted in FIG. 1, but in other embodiments a brim 116 can be curved or can have any other known and/or convenient geometry.

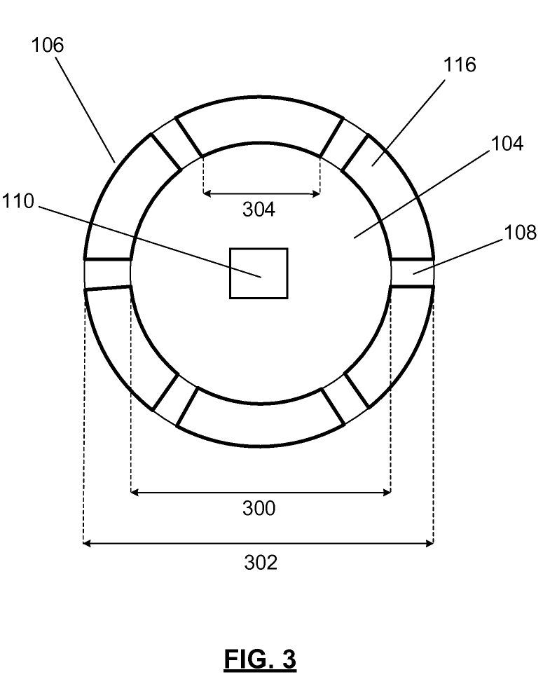

A substantially tubular body 102 can have a substantially circular cross-section, as shown in FIG. 3, or can have any other known and/or convenient cross-section geometry conducive to mating with a desired hub locknut. In some embodiments, the exterior surface of a substantially tubular body 102 can have ridges, indentations, small protrusions, or any other known and/or convenient surface characteristic for preventing slippage during handling or improving aesthetic appearance. In other embodiments, the exterior surface of a substantially tubular body 102 can be smooth.

Referring to FIG. 2, a substantially tubular body 102 can have dimensions appropriate for selective coupling with a desired hub locknut. The hub locknut socket 100 depicted in FIGS. 1-3 is adapted for use with a Myers hub locknut 206 (FIG. 2A), which is currently manufactured by several companies. In some embodiments of a hub locknut socket 100 designed to mate with a Myers hub locknut, a substantially tubular member 102 can have an inside diameter 300 of 1.075-1.560 inches, and an outside diameter 302 of 1.375-1.875 inches (FIG. 3). These dimensions represent dimensions complementary to common Myers hub locknuts currently on the market; however, inside and outside diameters 300 302 of a hub locknut socket 100 can have any other known and/or convenient dimensions.

A plurality of extension members 106 is illustrated in FIGS. 1-3. Similar to the substantially tubular body 102 above, in some embodiments, the exterior surface of an extension member 106 can have ridges, indentations, small protrusions, or any other known and/or convenient surface characteristic for preventing slippage during handling or improving aesthetic appearance. In other embodiments, the exterior surface of an extension member 106 can be smooth. Moreover, the brim 116 of an extension member 106 can be coated with a non-slip material adapted to provide improved grip when mating with a hub locknut. A non-slip coating can be rubber or another type of polymer, and/or can have small surface variations to increase friction between an extension member 106 and a hub locknut.

As illustrated in FIG. 2-2A and as explained above, a hub locknut socket 100 can be adapted for use with a Myers hub locknut 206. In this configuration, each extension member 106 can be adapted to fit closely between each lug 208 of a Myers hub locknut 206. In such embodiments, an extension member 106 can be 0.250-0.280 inches in height 200. Referring to FIG. 3, the inner width 304 of an extension member 106 can be 0.390-0.615 inches. These dimensions represent dimensions complementary to common sizes of Myers hub locknuts currently on the market; however, in other embodiments an extension member 106 can have any other appropriate dimensions.

In some embodiments, the thickness of an extension member 106 can be substantially similar to the thickness of the wall 114 of a substantially tubular member 102, as shown in FIG. 2. In other embodiments, the thickness of an extension member 106 can have a different thickness than that of a substantially tubular member 102. An extension member 106 can have an angle of curvature about the central longitudinal axis of a substantially tubular member 102 substantially similar to that of a substantially tubular body 102, as illustrated in FIGS. 1-3. In other embodiments, the angle of curvature of an extension member 106 can be different than that of a substantially tubular body 102 while still maintaining the proper geometry and dimensions for use with a desired hub locknut. As shown in FIGS. 1-2, an extension member 106 can have a substantially orthogonal geometry, but in other embodiments an extension member 106 can have a more rounded configuration, or can have any other known and/or convenient geometry. A brim 116 of an extension member 106 can be substantially planar. In other embodiments, a brim 116 can be slightly rounded to allow for easier placement a hub locknut, especially for situations where there is limited space and/or user vision is restricted. In alternate embodiments, a brim 116 can have any other known and/or convenient geometry.

A substantially tubular body 102 and/or a plurality of extension members 106 can comprise any type of known and/or convenient material and can have any known and/or convenient material properties. In one embodiment, a substantially tubular body 102 and/or a plurality of extension members 106 can be made of steel alloys, such as chrome vanadium or chrome molybdenum. In other embodiments, a substantially tubular body 102 and/or a plurality of extension members 106 can comprise any other known and/or convenient type of metal. In yet alternate embodiments, polyvinyl chloride or any other known and/or convenient polymer can be used. In some embodiments, a combination of materials can be used.

A substantially tubular body 102 and/or a plurality of extension members 106 can have corrosion-resistance properties, either inherently or by coating or plating with chrome, corrosion-resistant plastics, or any other known and/or convenient material. A substantially tubular body 102 and/or a plurality of extension members 106 made of steel can be heat treated to harden or soften the material, depending on intended application. For example, if a hub locknut socket 100 is intended for use as a standard socket, it can be treated such that the result is strong, brittle steel. If a hub locknut socket 100 is intended for use as an impact socket, it can be treated such that the result is weaker, more malleable steel that can deform and split instead of shattering in the event of an accident or misuse. In some embodiments, a steel substantially tubular body 102 and/or a plurality of steel extension members 106 can be oil-quenched, or can be treated by any other type of quenching process.

As depicted in FIGS. 1-2, the gap 108 of a hub locknut socket 100 for use with a Myers hub locknut can have a width 202 of approximately 0.155-0.165 inches. These dimensions are non-limiting and the width of gaps 108 can be adapted for use with any other size of Myers hub locknuts, with T&B® (electrical fitting/connector) hub locknuts (explained in detail below), and/or any other known and/or convenient type of hub locknut.

A flange 104 can be relatively thin, as shown in FIG. 1, or relatively thick, as shown in FIG. 2. The flange 104 illustrated in FIG. 2 can have a thickness 204 of approximately 0.4375 inches. In this embodiment, a cavity 110 and a flange 104 can have substantially similar thicknesses. In other embodiments, a cavity 110 and a flange 104 can have varied thicknesses with respect to each other (as shown in FIG. 1). Moreover, a flange 104 can be constructed of steel, plastic, or any other known and/or convenient type of material or combination of materials. In some embodiments, a flange 104 can comprise the same material as a substantially tubular body 102 and/or extension members 106.

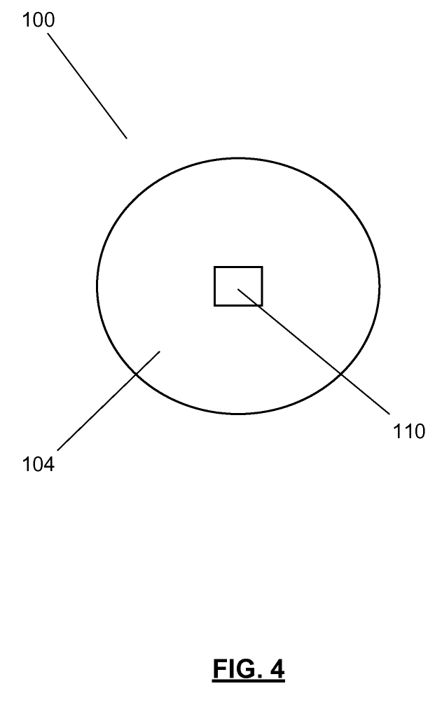

A cavity 110 is illustrated in FIGS. 1-4, and a ball detent 112 is shown in FIGS. 1-2. A cavity 110 can be a substantially rectangular opening and can be adapted to receive a standard or custom ratchet drive. A cavity 110 can be a depression having only one open end, as shown in FIG. 1, or can be an aperture having two open ends, as shown in FIG. 2. A ball detent 112 can receive the ball of a ratchet drive, if the drive is so equipped. This ball/ball-detent mechanism can temporarily lock the drive in place as an added safety measure and to aid in efficient use of a hub locknut socket 100.

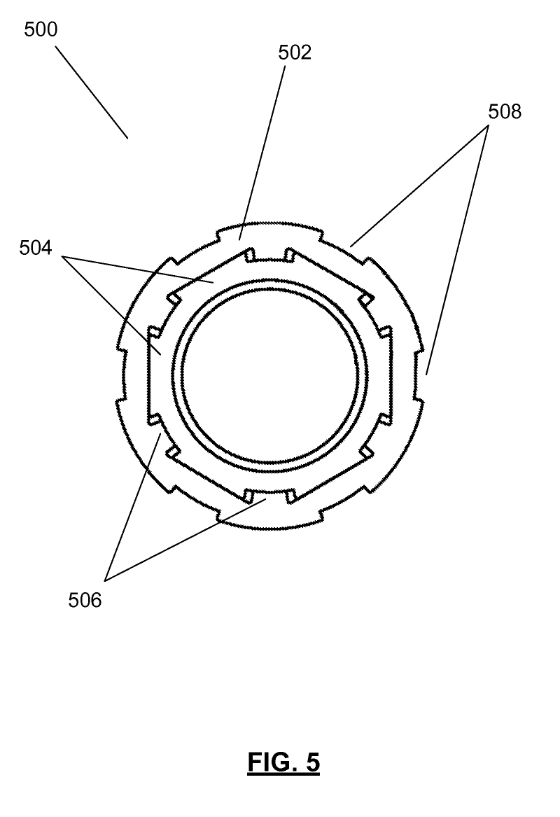

In some embodiments, a hub locknut socket 100 can be adapted to selectively couple with a T&B® (electrical fitting/connector) hub locknut 500, illustrated in FIG. 5. Currently, there are no socket tools appropriate for loosening and tightening a T&B® (electrical fitting/connector) hub locknut. At this time, Thomas & Betts® is the sole manufacturer of the type of hub locknut 500 depicted in FIG. 5; however, modifications to a hub locknut socket 100 can be made in the event of introduction to the market of variations on the T&B® (electrical fitting/connector) hub locknut configuration. A T&B® (electrical fitting/connector) hub locknut 500 can have a circular flange 502 coupled with a circular series of lugs 504. A plurality of angled splines 506 can be spaced between lugs 504, and a flange 502 can have flange indentations 508.

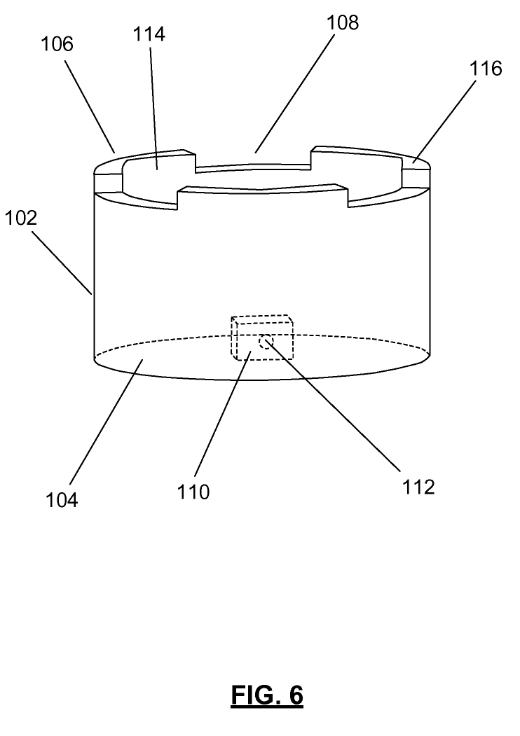

A hub locknut socket 100 adapted to mate with a T&B® (electrical fitting/connector) hub locknut is depicted in FIG. 6. This embodiment is similar to the hub locknut socket 100 shown in FIG. 1, however it comprises three (3) substantially equally spaced extension members 106. Additionally, while the FIG. 1 embodiment has a brim 116 of uniform depth, each brim 116 of extension members 106 in FIG. 6 can have varied width due to the angled geometry of extension members 106. In use, this angled geometry allows each extension member 106 to detachably couple with the exterior edges of two lugs 504 at least partially. As a whole, the extension members 106 of a hub locknut socket 100 adapted for use with a T&B® (electrical fitting/connector) hub locknut 500 can act to substantially circumferentially couple with lugs 504.

A hub locknut socket 100 can be designed for use with T&B® (electrical fitting/connector) hub locknuts and can have dimensions complementary to common T&B® (electrical fitting/connector) hub locknuts currently on the market. In other embodiments, a hub locknut socket 100 can have dimensions appropriate for coupling with hub locknut variants of the T&B® (electrical fitting/connector) hub locknut 500.

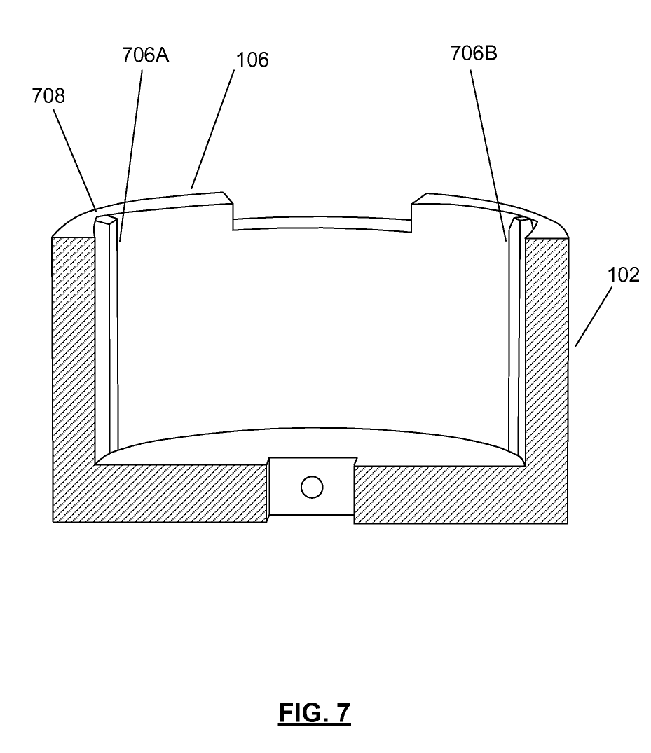

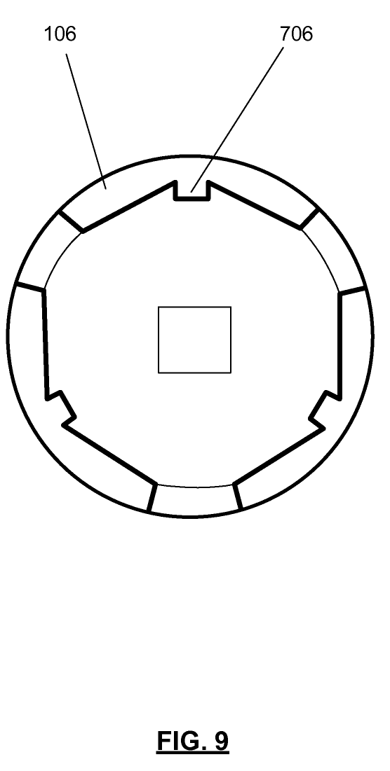

As depicted in FIGS. 7 and 9, each extension member 106 of a hub locknut socket 100 adapted to mate with a T&B® (electrical fitting/connector) hub locknut 500 can further comprise a rib member 706. A rib member 706 can be positioned substantially proximate to the interior vertex 708 of an angled extension member 106 and substantially parallel to the longitudinal plane of a substantially tubular member 102. A rib member 706 can be adapted to engage the spline 506 of a T&B® (electrical fitting/connector) hub locknut 500, thereby enabling greater surface area contact between a hub locknut socket 100 and a locknut 500. This can provide a more efficient grip by temporarily locking into place a hub locknut socket 100 and a hub locknut 500. Improved placement can also be achieved because, as force is applied to a hub locknut 500, rib members 706 of a hub locknut socket 100 can descend into splines 506, thereby guiding the hub locknut socket 100 into place. As shown in FIG. 7, the proximal end of a rib member 706 can be substantially orthogonal to a substantially planar surface (706A), or slightly angled with a substantially planar end surface (706B). In other embodiments, the proximal end of a rib member 706 can have any other known and/or convenient geometry.

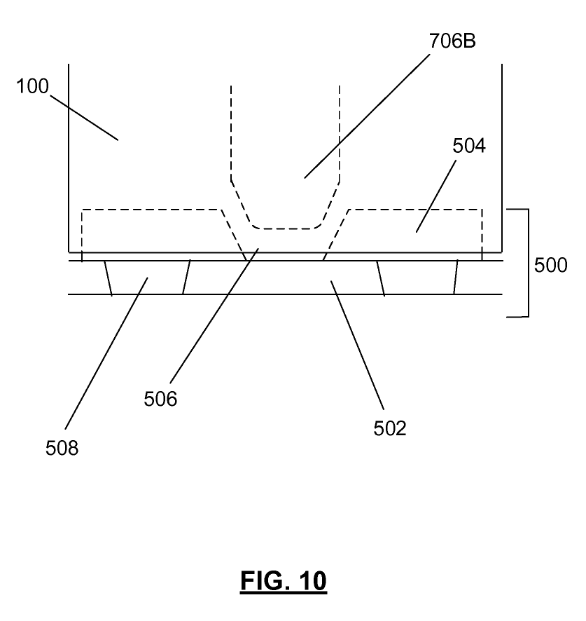

FIG. 10 depicts a sectioned side view of a T&B® (electrical fitting/connector) hub locknut 500 coupled with a hub locknut socket 100. The proximal end of a rib member 706B can be angled such that it complements the geometry of an angled spline 506 of a locknut 500. The proximal end of a rib member 706B can also have slightly rounded edges. This combination of an angled end and rounded edges can greatly improve the placement efficiency and ease of use of a hub locknut socket 100 by allowing rib members 706 to slide into angled splines 506, even when a user's view of the hub locknut socket 100 and locknut 500 is restricted.

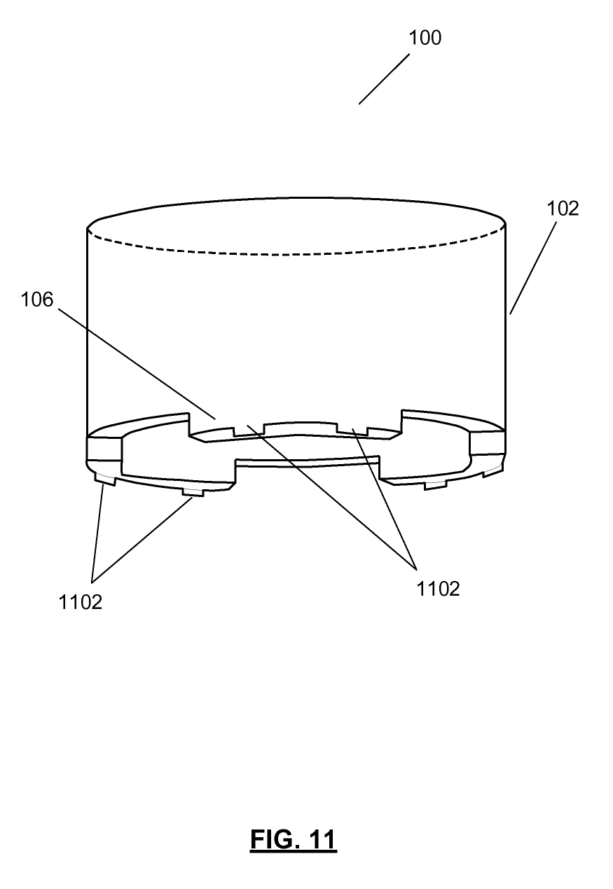

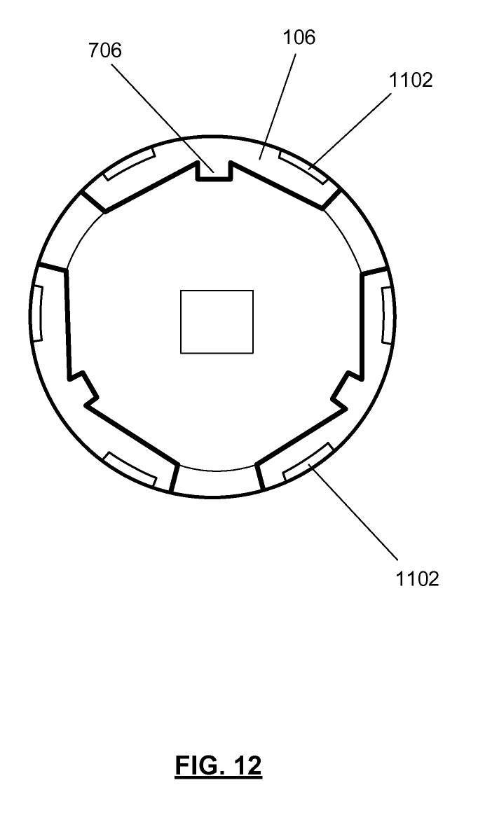

FIG. 11 illustrates another embodiment of a hub locknut socket 100 for use with a T&B® (electrical fitting/connector) hub locknut 500. A hub locknut socket 100 can further comprise a plurality of appendages 1102 coupled with the proximal ends of extension members 106. Appendages 1102 can be adapted to engage flange indentations 508 of a T&B® (electrical fitting/connector) hub locknut, thereby further increasing the surface area contact between a hub locknut socket 100 and locknut 500, thus improving the grip of a hub locknut socket 100 on a locknut 500. FIG. 12 depicts a top view of an alternate embodiment of a hub locknut socket 100. As shown, two appendages 1102 can be positioned on each extension member 106 such that appendages 1102 can complementarily mate with flange indentations 508 when in use.

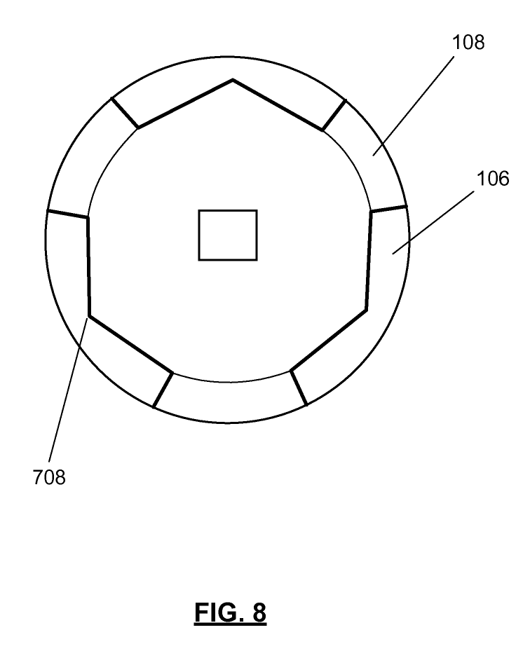

A hub locknut socket 100 can be adapted for use with a variety of tools. The hub locknut socket 100 in FIGS. 1-2, 3-4, 6-9, 12 is designed to receive the drive of a conventional socket wrench. In other embodiments a hub locknut socket 100 can be adapted to selectively couple with a custom ratchet, t-handle socket wrench, hand-held electric driver tools, pneumatic tools, such as an impact wrench, and/or any other known and/or convenient tool. Moreover, a hub locknut socket 100 can be adapted for use with wrench adapters, extensions, universal joints, knuckles, and/or any other known and/or convenient tool accessory. Although several embodiments have been described for use with Myers and T&B® (electrical fitting/connector) hub locknuts, the invention can be modified to selectively engage any other known and/or convenient type of hub locknut.

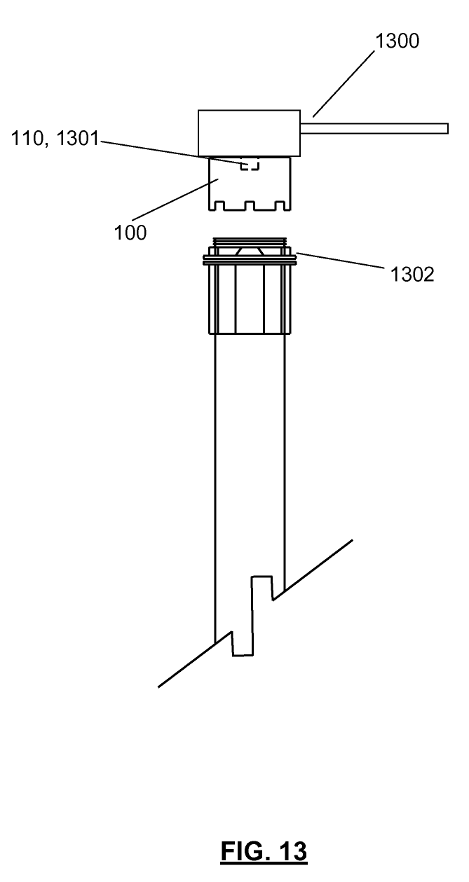

As shown in FIG. 13, the drive 1301 of a ratchet 1300 can be temporarily coupled with a hub locknut socket 100 via a cavity 110. A user can then mate the hub locknut socket 100 with a hub locknut 1302. In a Myers hub locknut embodiment (FIGS. 1-2A), extension members 106 of a hub locknut socket 100 can each slide between lugs 208 of the locknut 206, and lugs 208 can couple with gaps 108, thereby temporarily securing the hub locknut socket 100 to the hub locknut 206. In a T&B® (electrical fitting/connector) hub locknut embodiment (FIGS. 5-9), extension members 106 can circumferentially engage lugs 504, at least partially. In embodiments where a hub locknut socket 100 comprises a plurality of rib members 706, rib members 706 can slide between the lugs 504 into splines 506, thereby temporarily securing the hub locknut socket 100 to the locknut 500. Referring back to FIG. 13, a user can subsequently rotate a ratchet 1300 such that a hub locknut socket 100 is likewise rotated in a desired direction. In both the Myers or T&B® (electrical fitting/connector) embodiments, the force of extension members 106 against a locknut 1302, instigated by the driving force of the ratchet 1300, can facilitate rotation of a hub locknut 1302. Thus, a user can efficiently tighten or loosen a locknut 1302.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed is:

1. A hub locknut socket tool, comprising:
a substantially tubular body having a proximal end, a distal end, an interior wall, and an exterior surface;
a flange coupled with said distal end of said substantially tubular body;
the center of said flange having a cavity;
said cavity having a substantially rectangular opening adapted to receive a ratchet drive;
a plurality of extension members extending from said proximal end of said substantially tubular body;
said extension members being separated from each other by a predetermined distance.

2. The hub locknut socket tool of claim 1, wherein the exterior surfaces of said extension members are substantially flush with said exterior surface of said substantially tubular body

3. The hub locknut socket tool of claim 1, wherein said substantially tubular body and said plurality of extension members are adapted to selectively engage a standard hub locknut.

4. The hub locknut socket tool of claim 1, wherein said substantially tubular body and said plurality of extension members are adapted to selectively engage a T&B® (electrical fitting/connector) hub locknut.
